(19) United States
(12) Patent Application Publication
(10) Pub. No.: US 2008/0108494 A1
(43) Pub. Date: May 8, 2008

(54) COMPOSITION OF MOLYBDENUM DISILICIDE AND THE APPLICATION OF THE SAME

(76) Inventors: DONG BIN HAN, SEOUL (KR); BAE YEON KIM, SEOUL (KR)

Correspondence Address: IPLA P.A., 3580 WILSHIRE BLVD., 17TH FLOOR, LOS ANGELES, CA, 90010, US

(21) Appl. No.: 11/775,651

(22) Filed: Jul. 10, 2007

(30) Foreign Application Priority Data
Nov. 4, 2006 (KR) 10-2006-0108619

(51) Int. Cl. C04B 35/14

(52) U.S. Cl. 501/133

(57) ABSTRACT

Disclosed is a molybdenum disilicide composition for preventing a low-temperature deterioration phenomenon and the application thereof. The present invention provides a molybdenum disilicide composition, which can improve the sinterability characteristics of a molybdenum disilicide heating element and a thick film paste heating element using the same by adding silicon (Si) to molybdenum (Mo) such that the ratio of the silicon (Si) to the molybdenum (Mo) ranges from 1:2.01 to 1:2.5, which is not a chemical quantitative ratio thereof of 1:2, at the time of self-propagating high-temperature synthesis (SHS) of the molybdenum disilicide, can reduce a low-temperature oxidation phenomenon because the added silicon component is oxidized in the atmosphere and thus forms an oxide film, and can efficiently prevent a low-temperature deterioration phenomenon, and the application thereof.

### CROSS REFERENCE

This application claims foreign priority under Paris Convention and 35 U.S.C. § 119 to Korean Patent Application No. 10-2006-0108619, filed Nov. 4, 2006 with the Korean Intellectual Property Office.

### TECHNICAL FIELD

The present invention relates to a molybdenum disilicide composition for preventing a low-temperature deterioration phenomenon and the application thereof, and, more particularly, to a molybdenum disilicide composition, which can improve the sinterability of a molybdenum disilicide heating element and a thick film paste heating element using the same by adding silicon (Si) to molybdenum (Mo) such that the ratio of the silicon (Si) to the molybdenum (Mo) ranges from 1:2.01 to 1:2.5, which is not a chemical quantitative ratio thereof of 1:2, at the time of self-propagating high-temperature synthesis (SHS) of the molybdenum disilicide, can reduce a low-temperature oxidation phenomenon because the added silicon component is oxidized in the atmosphere and thus forms an oxide film, and can effectively prevent a low-temperature deterioration phenomenon, and the application thereof.

### BACKGROUND ART

A carbon heating element which can be used in a vacuum or an inactive atmosphere, a metal heating element such as molybdenum (Mo), platinum (Pt) or tungsten, and a ceramic heating element such as silicon carbide (SiC) or molybdenum disilicide (MoSi₂), which can be used in the atmosphere, are used as a heating element for attaining a high temperature of 600° C. or more using electricity. Among these heating elements, as a heating element which can generate heat to a temperature of 600° C. or more, a nickel-chrome based nichrome wire and a iron-chromium based iron-chromium wire (brand name: Kanthal), which can generate heat to a temperature of about 1250° C., a silicon carbide (SiC) heating element, which can generate heat to a temperature of about 1400° C., a platinum heating element, which can generate heat to a temperature of about 1500° C., and a molybdenum disilicide heating element, which can generate heat to a temperature of 1800° C., are generally used as heating elements in firing furnaces.

Among these heating elements, which can generate heat to a temperature of 600° C. or more, the molybdenum disilicide heating element, which can generate heat to a temperature of 1800° C., is produced through processes of mixing molybdenum with silicon at a ratio of 1:2 to obtain a mixture; synthesizing a raw material powder with the mixture using a high temperature reaction synthesis or a self-propagating high-temperature synthesis (SHS); molding the raw material powder through an extrusion process or a thick film forming process; and sintering the molded resultant product. The molybdenum disilicide heating element produced through the above steps is used in a heating element or a high-temperature support. This molybdenum disilicide has the following advantages: first, this molybdenum disilicide can be used at high temperatures, and second, this molybdenum disilicide can also be stably used at a high temperature of 1800° C. because, when it is heated to high temperatures under atmospheric conditions, a silicon (Si) component included in the molybdenum disilicide combines with oxygen to form a silicon dioxide antioxidant film on the surface of the heating element, thereby preventing the molybdenum disilicide from oxidizing any further. However, when the molybdenum disilicide heating element is used for a long time at a low temperature of 900° C. or less, there is a problem in that the molybdenum disilicide is excessively oxidized, so that excessive antioxidant film is formed, with the result that the heating element is deteriorated, thereby limiting the use of the heating element at low temperatures.

Further, when this molybdenum disilicide is used as a heating element, a step-down transformer and the associated devices are required, because the molybdenum disilicide has low electric resistance, and thus works at a low voltage ranging from 4 to 10 V and a high current ranging from 0.5 to 30 A. In order to overcome these problems, a method of producing a heating element, in which molybdenum disilicide is formed into a thick film paste, and then the thick film paste is formed into the heating element through an insulating ceramic printing process, has been proposed. The method of producing a heating element has an advantage in that the heating element can be heated at a voltage suitable for home or industrial use without using additional devices because electric resistance is increased due to the shape characteristics of the conductive circuit, in which the cross section area thereof is decreased and the length thereof is increased. However, the method of producing a heating element also has a disadvantage in that electric resistance is increased as the circuit length is increased and the line width is decreased. Accordingly, it is required to finely adjust the circuit length and the line width in order to control the electric resistance.

Further, in the thick film heating element, when carbon is used as the thick film heating element, the carbon is mainly used at a low temperature of 200° C. or less, but cannot be easily used at a temperature of 400° C. or more because the carbon is oxidized at temperatures of 400° C. or more. When tungsten (W) is used as the thick film heating element, the tungsten is of limited usefulness, because the tungsten is also oxidized. Moreover, a silver (Ag)-based thick film heating element or a silver-palladium (Ag—Pd)-based thick film heating element is expensive and uneconomical. Accordingly, the development of a composition for a heating element, which is cheap and economical and can prevent a deterioration phenomenon at a predetermined temperature, is required.

### DISCLOSURE

### Technical Problem

Accordingly, the present invention has been made in order to solve the above problems occurring in the prior art, and an object of the present invention is to provide a molybdenum disilicide composition for preventing a low-temperature deterioration phenomenon due to the excessive oxidation of the molybdenum disilicide at a relatively low temperature of 600° C. or less.

Another object of the present invention is to provide a molybdenum disilicide composition, which can be more easily formed into a complicated shape by improving high-temperature workability derived from a frit component, eliminate a molybdenum disilicide mixing process for molding by adding the frit component, such as silicon dioxide, during a raw material mixing process, and reduce processing times by increasing mixing efficiency.

A further object of the present invention is to provide a molybdenum disilicide composition, which can prevent the excessive increase of electric resistance by adding a conductive material to the molybdenum disilicide composition.

### Technical Solution

In order to accomplish the above objects, the present invention provides a molybdenum disilicide composition, wherein the molar ratio of molybdenum (Mo) to silicon (Si) ranges from 1:2.01 to 1:2.5.

Here, it is preferred that, when the molybdenum disilicide composition is synthesized, silicon dioxide be quantitatively added to the molybdenum disilicide composition such that the molar ratio of the amorphous silicon dioxide to the molybdenum disilicide composition ranges from 1:0.01 to 1:0.5.

It is preferred that the silicon dioxide be amorphous silicon dioxide.

It is preferred that a conductive material be further added to the molybdenum disilicide composition.

It is preferred that the conductive material be tungsten (W), molybdenum (Mo) or a mixture (W+Mo) thereof.

It is preferred that the tungsten (W), the molybdenum (Mo) or the mixture (W+Mo) thereof be quantitatively added to the molybdenum disilicide composition such that the amount of the tungsten (W), the molybdenum (Mo) or the mixture (W+Mo) is 1˜50 volume % of the volume of the molybdenum disilicide composition.

It is preferred that bentonite, which is a molding agent, be further added to the molybdenum disilicide composition such that the amount of the bentonite is 1˜30 weight % of the weight of the molybdenum disilicide composition.

When the molybdenum disilicide composition prepared as described above is synthesized and heat-treated, silicon (Si) is added in excess to the matrix of the molybdenum disilicide composition synthesized by a SHS reaction, and thus non-reacted silicon (Si) is uniformly distributed. While the molybdenum disilicide heating element, synthesized as such, generates heat, the remaining non-reacted silicon component reacts with oxygen in the atmosphere to form silicon dioxide, and the formed silicon dioxide is uniformly formed on the surface of the molybdenum disilicide. Since the silicon dioxide formed on the surface of the molybdenum disilicide serves an antioxidant film for preventing a low-temperature deterioration phenomenon due to the oxidation of the molybdenum disilicide and the remaining silicon component serves as a sintering agent, the density of the molybdenum disilicide is increased, and the compactness thereof is enhanced because the silicon dioxide block pores. Accordingly, the molybdenum disilicide composition according to the present invention can serve to prevent a fast phenomenon from being caused by the reaction of conventional molybdenum disilicide and atmospheric oxygen, can have good adhesion to an insulating ceramic substrate, and can impart workability by forming a viscous fluid at the time of manufacturing a heating element.

Further, it is preferred that, when the molybdenum disilicide composition is synthesized, the silicon dioxide be quantitatively added to the molybdenum disilicide composition such that the molar ratio of the amorphous silicon dioxide to the molybdenum disilicide composition ranges from 1:0.01 to 1:0.5. Accordingly, the molybdenum disilicide composition can have increased workability due to a softening phenomenon when a heating element is manufactured at a low temperature by uniformly distributing the silicon dioxide in the molybdenum disilicide composition (MoSi₂₊ₓ) in the process of synthesizing the molybdenum disilicide composition, can mitigate the increase in mixing time and the complexity of processes conducted when the silicon dioxide is mixed after the process of synthesizing the molybdenum disilicide composition, rather than during the synthesis thereof, and can reduce a separation phenomenon due to the difference in specific gravity between the two materials and a working defective fraction due to incomplete mixing.

Further, it is preferred that the molybdenum disilicide composition further include tungsten (W), molybdenum (Mo) or a mixture (W+Mo) thereof, each of which is a conductive material, according to an embodiment of the present invention. Here, when the molybdenum disilicide composition according to the present invention is prepared in the form of a paste and is used for manufacturing a thick film heating element, it can be used without including the above metal material. However, when the line width of a circuit realized by the paste is narrow and the molybdenum disilicide composition is applied to a circuit having a large area, the electric resistance of the molybdenum disilicide composition can be adjusted by adding the above conductive metal material in order to control the increase in the electric resistance thereof. Further, it is preferred that the tungsten (W), the molybdenum (Mo) or the mixture (W+Mo) thereof be quantitatively mixed with the molybdenum disilicide composition such that the amount of the tungsten (W), the molybdenum (Mo) or the mixture (W+Mo) is 1˜50 volume % of the volume of the molybdenum disilicide composition. Particularly, it is preferred that the tungsten (W), the molybdenum (Mo) or the mixture (W+Mo) thereof be used in the form of powder.

Further, it is preferred that the molybdenum disilicide composition further include bentonite as a molding agent such that the amount of the bentonite is 1˜30 weight % of the weight of the molybdenum disilicide composition.

Further, it is preferred that the molybdenum disilicide composition be prepared through reaction synthesis or self-propagating high-temperature synthesis.

Further, the present invention provides a molybdenum disilicide composition, in which 55˜100 weight % of molybdenum disilicide and 0˜45 weight % of frit are mixed, and the content of silicon dioxide in the frit is 90˜100 weight % of the frit.

Further, the molybdenum disilicide composition may be used in various heating elements for generating heat using electricity, thick film heating elements and pastes for the thick film heating elements which are formed on a printed circuit board using a screen printing, pad transfer printing or dip coating method, or tungsten or molybdenum-manganese conductive circuits of ceramic layered parts.

### Advantageous Effects

As described above, according to the present invention, the sintering characteristics of a molybdenum disilicide heating element and a thick film paste heating element using the same can be improved; and the added silicon component is oxidized in the atmosphere and thus forms an oxide film, so that a low-temperature oxidation phenomenon can be suppressed, thereby preventing a low-temperature deterioration phenomenon.

Further, according to the present invention, a conventional process of mixing molybdenum disilicide and silicon dioxide frit need not be performed because silicon is added in excess, or the silicon dioxide is added before the time of synthesis of the molybdenum disilicide.

Further, according to the present invention, since a separation phenomenon due to the difference in specific gravity between molybdenum disilicide and silicon dioxide, occurring during the process of mixing the molybdenum disilicide and the silicon dioxide, can be prevented, the uniformity of mixing can be maintained, and thus the reliability of the product can be improved.

Further, according to the present invention, since silicon dioxide is previously mixed with molybdenum disilicide before the synthesis of the molybdenum disilicide, a conductive thick film paste composition, prepared in a state in which the molybdenum disilicide and silicon oxide are uniformly mixed, and a circuit thereof can have excellent adhesion to an insulating substrate.

Further, according to the present invention, when the molybdenum disilicide composition, in which frit, including silicon dioxide as a major component, is added, is worked in the form of a heating element, electric resistances are controlled to have low values by adding molybdenum, tungsten or a mixture thereof, which is a conductive material, to the molybdenum disilicide composition, so that the molybdenum disilicide composition can be used in a range of voltage for home or industrial use without requiring additional voltage control devices when it is used for a conductive thick film heating element, etc.

### Mode for Invention

Hereinafter, the present invention will be described in detail with reference to the accompanying embodiments.

In the molybdenum disilicide (MoSi₂) composition according to an embodiment of the present invention, it is preferred that molybdenum (Mo) and silicon (Si) be mixed at a weight ratio of 56.94:56.18 such that the weight ratio corresponds to a stoichiometric mixture ratio of 1:2. However, in the molybdenum disilicide (MoSi₂) composition according to the present invention, it is preferred that molybdenum (Mo) and silicon (Si) be mixed such that the mixing ratio of the molybdenum (Mo) to the silicon (Si) ranges from 100:99.6 to 100:148 by weight. The mixture of molybdenum and silicon mixed at this mixing ratio is synthesized into a molybdenum disilicide (MoSi₂) composition by performing a high-temperature reaction or using a self-propagating high-temperature synthesis.

Non-reacted silicon is uniformly distributed in the obtained molybdenum disilicide composition. Accordingly, when the molybdenum disilicide composition is heat-treated in the atmosphere, the silicon component reacts with oxygen to form a uniform and compact silicon dioxide film, so that this silicon dioxide film inhibits the infiltration of oxygen, thereby preventing a low-temperature deterioration phenomenon due to the excessive oxidation of the molybdenum disilicide. Furthermore, since this silicon serves as a sintering agent at high temperatures, the sintering temperature and time of the molybdenum disilicide composition can be decreased, and the high-temperature workability thereof can also be improved.

Further, according to another embodiment of the present invention, silicon dioxide (SiO₂), which can impart high-temperature workability to the molybdenum disilicide composition, may be added at the time of synthesis of the molybdenum disilicide composition. In this case, compared to the case where silicon dioxide is added to molybdenum disilicide to mold the composition after the synthesis of the composition, since a bond structure of molybdenum, silicon dioxide and molybdenum disilicide, such as Mo—Si—O—Si—O—Si—Mo, is previously formed, a molybdenum disilicide composition having a more compact structure can be obtained, and a separation phenomenon due to the difference in specific gravity between the molybdenum disilicide powder, having a specific gravity of 5.6 g/cm³, and a silicon dioxide component having a specific gravity of 2.2-2.6 g/cm³, does not occur, and thus the molybdenum disilicide powder and the silicon dioxide component are uniformly mixed, so that a raw material mixing process requiring a long period may not be performed. In this case, it is preferred that the amount of silicon dioxide added at the time of synthesis of the raw material be 50 weight % or less compared to the weight of molybdenum disilicide. When the amount of silicon oxide is above 50 weight %, the molybdenum disilicide composition loses electric conductivity, and thus cannot be used as a heating element.

The synthesized molybdenum disilicide is manufactured through a typical process such as extrusion or powder press formation, and can be used as a high-temperature heating element or as a high-temperature support. Furthermore, the synthesized molybdenum disilicide can be manufactured into a paste for thick film printing by adding various organic materials thereto and performing a mixing process such as 3-roll milling.

In this case, in order to improve high-temperature workability and prevent a low-temperature deterioration phenomenon, it is preferred that silicon dioxide be added to the molybdenum disilicide composition to 30 weight % of the total weight of the composition. Here, it is preferred that the silicon dioxide be amorphous silicon dioxide.

Further, in order to increase workability, bentonite may be added to the molybdenum disilicide composition to 30 weight %, and preferably 20 weight % of the weight of the composition.

Moreover, both amorphous silicon dioxide and bentonite may be added to the molybdenum disilicide composition to 40 weight % of the weight of the composition. Here, it is preferred that the amorphous silicon dioxide have a particle diameter of 30 μm or less (D₉₅) and a purity of 98%. When non-amorphous silicon dioxide is used, there are problems in that products are cracked owing to the displacement transformation between crystals thereof, and workability is decreased because the silicon oxide does not turn into a viscous fluid and melts at high temperature.

In the case where the molybdenum disilicide composition is produced to manufacture a thick film paste, since a printed circuit possesses the characteristics of a thin line width and a low height, the resistance of the heating element is increased, and the resistance thereof must be adjusted to have a low value. Accordingly, a conductive metal material may be included in the composition to decrease the electric resistance. Preferably, molybdenum, tungsten or the mixture thereof may be added to the composition to 50 volume % of the volume of the composition in order to decrease the resistance value. Here, it is preferred that the conductive metal material be added to the composition in the form of powder.

The above molybdenum disilicide composition can be used as various heating elements and high-temperature supports through an extrusion process or a sintering process. Further, the molybdenum disilicide composition can be used as a thick film heating element through the following processes of forming the molybdenum disilicide composition into powder, forming the powder into a printing paste using typical methods, layering the printing paste on an insulating ceramic substrate, and heat-treating the layered paste. Since this thick film heating element, manufactured through the above processes, is characterized in that the calorific value thereof is much higher than that of a conventional thick film heating element, the operational temperature is high, and a temperature raising rate is high, it can be used for various electric heating parts and apparatuses such as drying apparatuses and heating apparatuses in semiconductor manufacturing processes and laser printers.

As described above, although the present invention is described with reference to preferred embodiments thereof, the present invention is not limited to the embodiments, and must be comprehended based on the claims.

What is claimed is:

1. A molybdenum disilicide composition, wherein a molar ratio of molybdenum (Mo) to silicon (Si) ranges from 1:2.01 to 1:2.5.

2. The molybdenum disilicide composition according to claim 1, wherein, when the molybdenum disilicide composition is synthesized, amorphous silicon dioxide is quantitatively added to the molybdenum disilicide composition such that a molar ratio of the amorphous silicon dioxide to the molybdenum disilicide composition ranges from 1:0.01 to 1:0.5.

3. The molybdenum disilicide composition according to claim 2, wherein, after the molybdenum disilicide composition is synthesized, the silicon dioxide is further added to the molybdenum disilicide composition such that an amount of the silicon dioxide is 30 weight % of total weight of the molybdenum disilicide composition.

4. The molybdenum disilicide composition according to claim 1, wherein a conductive material is further added to the molybdenum disilicide composition.

5. The molybdenum disilicide composition according to claim 2, wherein a conductive material is further added to the molybdenum disilicide composition.

6. The molybdenum disilicide composition according to claim 3, wherein a conductive material is further added to the molybdenum disilicide composition.

7. The molybdenum disilicide composition according to claim 4, wherein the conductive material is tungsten (W), molybdenum (Mo) or a mixture (W+Mo) thereof.

8. The molybdenum disilicide composition according to claim 5, wherein the tungsten (W), the molybdenum (Mo) or the mixture (W+Mo) thereof is quantitatively added to the molybdenum disilicide composition such that an amount of the tungsten (W), the molybdenum (Mo) or the mixture (W+Mo) is 1˜50 volume % of volume of the molybdenum disilicide composition.

9. The molybdenum disilicide composition according to claim 1, wherein bentonite, which is a molding agent, is further added to the molybdenum disilicide composition such that an amount of the bentonite is 1˜30 weight % of weight of the molybdenum disilicide composition.

10. The molybdenum disilicide composition according to claim 2, wherein bentonite, which is a molding agent, is further added to the molybdenum disilicide composition such that an amount of the bentonite is 1˜30 weight % of weight of the molybdenum disilicide composition.

11. The molybdenum disilicide composition according to claim 3, wherein bentonite, which is a molding agent, is further added to the molybdenum disilicide composition such that an amount of the bentonite is 1˜30 weight % of weight of the molybdenum disilicide composition.
